(19) United States
(12) Patent Application Publication
(10) Pub. No.: US 2026/0334432 A1
(43) Pub. Date: Oct. 29, 2026

(54) BRUSH FOR GROOMING DOMESTIC ANIMALS

(71) Applicant: MINELLI S.P.A., COSTA SERINA (BG) (IT)

(72) Inventors: Paolo FIORONI, Missaglia (LC) (IT); Dino CORTINOVIS, Costa Serina (BG) (IT); Luca MINELLI, Mozzo (BG) (IT)

(21) Appl. No.: 19/650,515

(22) Filed: Apr. 17, 2026

(30) Foreign Application Priority Data
Apr. 28, 2025 (IT) 102025000009291

(51) Int. Cl. A01K 13/00; A46B 7/04

(52) U.S. Cl. CPC A01K 13/002; A46B 7/042; A46B 2200/1093

(57) ABSTRACT

A brush for grooming domestic animals includes a handle (2) integrally joined with a brush head (3) carrying a plurality of prongs (4) with protruding ends adapted to interact with the fur of an animal. The brush head (3) includes a plurality of parts (8, 10, 30) coupled to each other mechanically and by interposing a perimeter retaining element (25).

This application claims the benefit of Italian Patent Application No. 102025000009291 filed on Apr. 28, 2025, the disclosure of which is incorporated herein by reference.

### TECHNICAL FIELD

The present invention relates to a brush for grooming domestic animals.

### BACKGROUND

As is known, when grooming a domestic animal, for example, a dog or a cat, a brush is used for carding the hair of the animal. This allows for effective removal of dead hair from the base of the animal fur, avoids the formation of entanglements and knots in the hair, and also smooths the hair of the animal.

Normally, a brush for grooming the animal, in particular for carding the fur, comprises a brush head associated with a handle. The head comprises a portion to which there is secured the handle and a part for supporting a plurality of protrusions or prongs adapted to come into direct contact with the hair of the animal. Such a support part is usually inserted into a seat of the portion secured to the handle and glued in said seat. Given that the grooming of the animal often provides for the washing thereof, the activity of carding the hair is carried out in a wet environment and on wet hair. As a result, the water present, even in a minimal amount, on the fur can penetrate the head of the brush, between the portion of the containment frame of the support part of the prongs and the support part, where a sponge (self-adhesive) is arranged for damping such support part of the prongs when brushing. Upon being wet, such a sponge may entail the formation of mould and bacteria, which can be harmful both to the operator carrying out the grooming and the animal.

Such a solution allows for avoiding the presence of water between the aforementioned parts of the brush, but it may, however, entail the formation of mould between the parts and the formation of bacteria, besides generating foul-smelling emissions, which can be harmful both to the operator carrying out the grooming and to the animal.

Besides this, due to the reasons mentioned above, the prior art brushes cannot be subjected to intense washing, and this increases the lack of hygiene over time, as they are used progressively.

### SUMMARY

An object of the present invention is to provide a brush for grooming a domestic animal, in particular for carding its fur, the brush being improved with respect to the prior art brushes.

Another object of the present invention is to provide a brush of the type indicated above that can be freely washed and that offers a high level of hygiene.

A further object is to provide a brush of the type mentioned above that is durable over time and offers a high mechanical strength when being used.

These and other objects, which shall be more apparent to the person skilled in the art, are attained by a brush according to the attached claims.

### BRIEF DESCRIPTION OF THE DRAWINGS

For a better understanding of the present invention, the following drawings are attached hereto, purely by way of non-limiting example, wherein:

FIG. 1 shows a perspective view of a brush according to the invention,

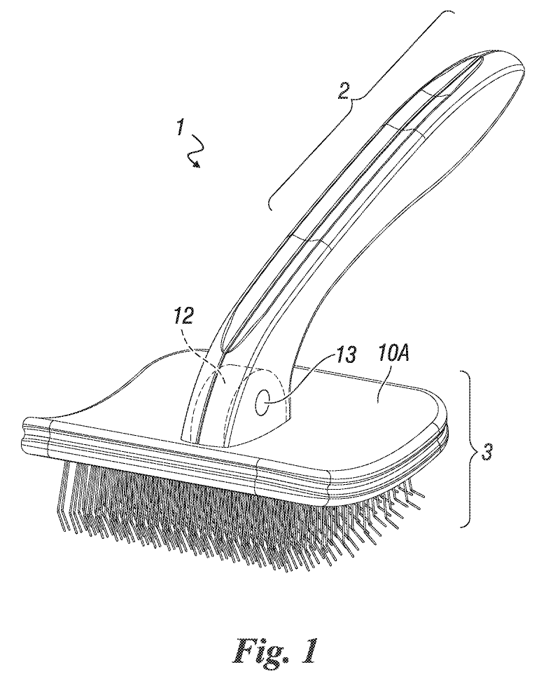

FIG. 2 shows an exploded perspective view of the brush of FIG. 1;

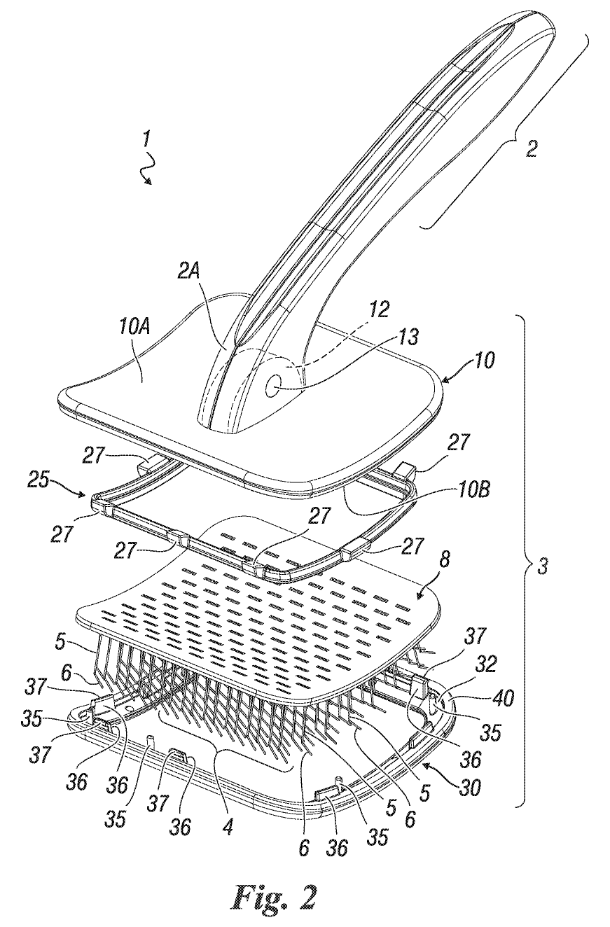

FIG. 3 shows an exploded perspective view of the brush of FIG. 1, but from another angle; and

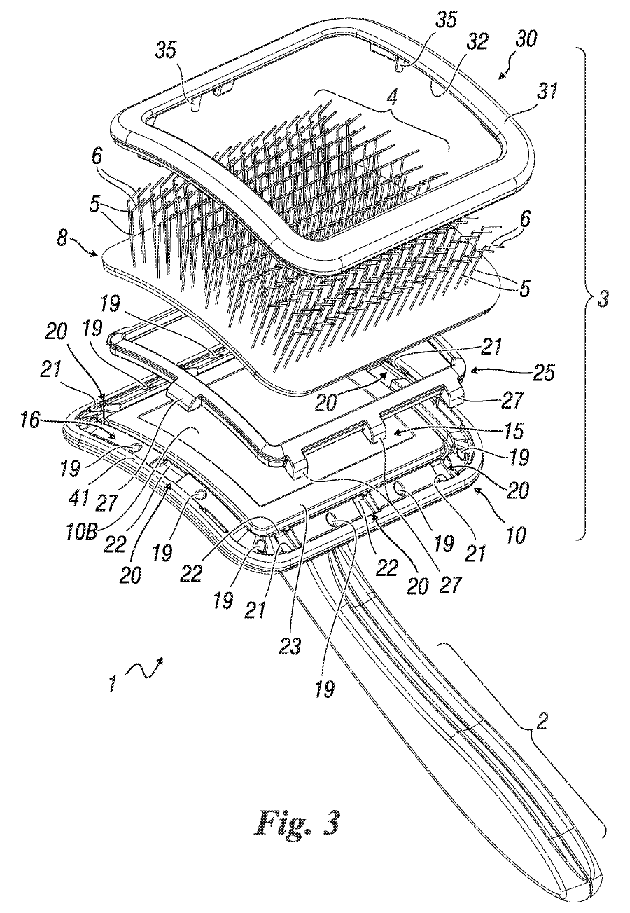

FIG. 4 shows an exploded perspective view from one side of the brush of FIG. 1.

### DETAILED DESCRIPTION

With reference to the figures mentioned above, a brush for grooming domestic animals, in particular for carding the fur of such animals, is generally indicated with 1. It comprises a handle 2, made of wood or plastic material, connected to a head of the brush 3 from which there protrude a plurality of prongs 4. Each of them has a stem 5 and an end portion 6, preferably slightly folded with respect to said stem. Each prong is metallic, for example, made of steel (galvanised/nickel-plated/chrome-plated).

The prongs 4 are associated with a support part 8 made of cloth-inserted rubber or equivalent material which offers to such part 8 a suitable flexibility, such as to allow the easy handling thereof.

The head of the brush 3 comprises a first portion 10, made of plastic material. Preferably, such portion 10 is made of recycled polypropylene in which there is dispersed a bacteriostatic agent free from waxes and lubricants.

The addition of such a bacteriostatic agent, per se known type, allows the obtaining of a plastic material which is not subject to attacks by microorganisms which would otherwise produce unpleasant smell, decolouration, or formation of stains. The material or bacteriostatic agent may, for example, be the product known under the trade name PE BATTERIOSTATICO 03250, also used for the production (by extrusion) of a single-layer or multi-layer film that is fine in thickness and, in particular, for the production of “disposable” gloves used in hospitals.

The first portion 10 may be flat-shaped or, as in the figures, slightly curved. Such first portion 10 comprises a first face 10A with which there is associated the handle 2 and a second opposite face 10B adapted to cooperate with the support part 8 of the prongs 4. Advantageously, from the first face 10A, a fin 12 rises, on which there is positioned an end part 2A of the handle 2 and to which such part 2A is constrained; a rivet 13 secures the handle to the head of the brush 3 through the first portion 10 of the latter.

As mentioned, the handle 2 may be made of wood; the outer surface thereof may also be embossed.

The second face 10B of the first portion 10 has a recess 15 adapted to act as a seat for supporting 8 the prongs 4. The recess or seat 15 of the support 8 is delimited by a raised edge 16 with respect to the bottom wall of the recess or seat 15 defined by the second face 10B of the first portion 10.

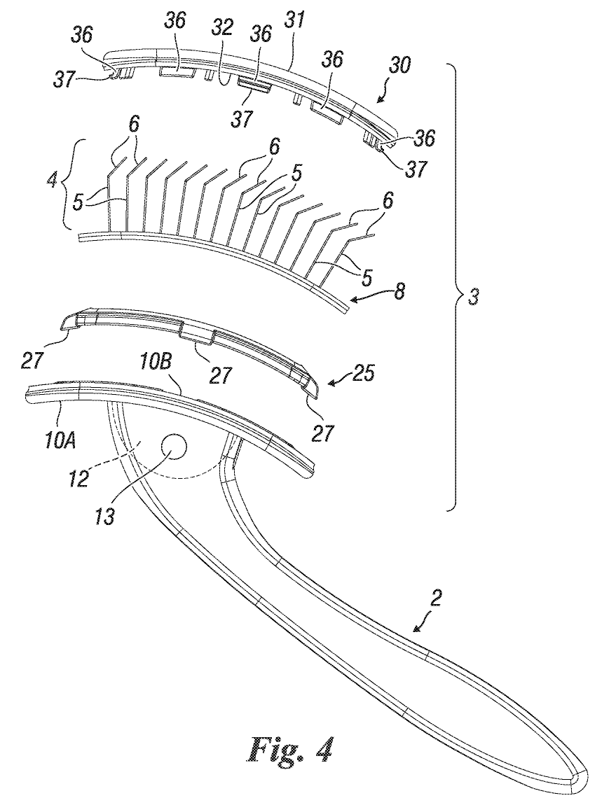

In seat 15, a usual damping sponge 15K is located, said sponge being shown with a dashed line only in FIG. 4.

In the raised edge 16 of the second face 10B of the first portion 10, there are present blind holes 19 and recesses 20; at least part of the latter has an undercut 21 at a first end arranged at the edge 16, while a second end 22, opposite to the first with the undercut 21, opens towards the seat or recess 15. Lastly, within the latter, there is arranged an edge or step 23 at the whole raised edge 16.

On such internal step 23 of the seat or recess 15 there rests a sealing element or gasket 25 shaped like such step or said seat or recess 15. The sealing element 25 is adapted to be arranged between the support 8 of the prongs 4, and such recess or seat, and it creates a fluid-tight sealing between them. In this manner, the water present on the fur of the animal subject to carding using the brush 1 cannot penetrate the recess or seat 15.

More particularly, the sealing element 25 has a plurality of protrusions 27 adapted to penetrate the recesses 20 provided in the edge 16.

The sealing element is preferably made of natural or synthetic rubber or made of an equivalent yieldable material.

Lastly, the head of the brush 3 comprises a frame 30 adapted to be superimposed on the support 8 of the prongs 4 and to retain the latter in the seat or recess 15 thereof without using glue. In particular, the frame 30 has a first face 31 and a second face 32, the first face being visible on the assembled head of the brush 3. On the contrary, the second face 32 comprises a plurality of pins 35 and protruding hook-shaped elements 36, at least part of the latter having a free hook-like end 37. The pins 35 are adapted to be inserted into the holes 19 of the edge 16 of the first portion 10, while the hook-shaped elements 36 are adapted to be inserted into the holes 20, above the protrusions 27 of the sealing element 25; such elements are engaged in said recesses due to the cooperation between the hook end 37 thereof and the undercut 21 of the corresponding recess.

The coupling of the frame 30 with said edge 16 of the first portion 10 creates a "packing" of the support 8 of the prongs 4 on the sealing element 25. This is thanks to the snap-coupling between the undercuts 21 and the hook-shaped elements 36 provided with a hook end 37, which, pressing on the support 8, crush it on the sealing element 25, which is in turn pressed on the edge 16, creating the sealing required to insulate the recess or seat 15 from the external environment.

Support 8 is therefore associated with the plastic of the head of the brush 3 without using glue.

Advantageously, the frame 30 has a raised perimeter part 40 at the second face 32 adapted to cooperate with a corresponding perimeter protruding part 41 of the raised edge 16 of the first portion 10 to fully enclose the edges of the head of the brush 3 and enclose (mechanically, as described) the sealing element 25 and the support 8 within such edges.

The brush 1 described above allows to obtain a product for carding the fur of a domestic animal which is waterproof and resistant; should the brush be fully made of plastic material or in cases where only the head of the brush 3 is made of plastic material, the product also has antibacterial features because the aforementioned plastic material is treated with an antibacterial product, and the head of the brush is shaped so as to prevent the infiltration and stagnation of water therein when using the brush.

Furthermore, the sealing is also assured when the carding of the fur occurs when using a phone: the hot air emitted by the latter deforms the sealing element 25, which therefore keeps the function thereof intact even during this step of grooming the domestic animal.

A particular embodiment of the invention has been described. The characteristics of the latter are however defined by the claims that follow.

1. A brush for grooming a domestic animal, said brush comprising a head of the brush with which there is associated a handle , from the head of the brush there protruding a plurality of prongs carried by a corresponding support adapted to be arranged at a seat of a second face of a first portion of said head of the brush , wherein between said second face of the first portion of the head of the brush and the support of the prongs there is present a sealing element which delimits the seat for said support , the latter being pressed and retained against such sealing element by a perimeter frame coupled to said first portion of the head of the brush.

2. The brush according to claim 1, wherein said perimeter frame comprises coupling and engagement members adapted to mechanically cooperate with corresponding holes and recesses provided for in the first brush portion and therefore retaining said support of the prongs coupled to said first portion of the head of the brush without using glue.

3. The brush according to claim 2, wherein said holes and recesses are provided for in a raised edge of the second face of the first portion of said head of the brush , at least part of said recesses having an undercut adapted to cooperate with a hook end of corresponding hook-shaped elements protruding from said perimeter frame .

4. The brush according to claim 3, wherein said recesses of the first brush portion also contain corresponding protrusions protruding from said sealing element, on said protrusions there being arranged the hook-shaped elements of the perimeter frame.

5. The brush according to claim 1, wherein said perimeter frame and said raised edge of the second face of the first portion of the head of the brush have raised perimeter parts adapted to come into mutual contact and enclose therein the support of the prongs .

6. The brush according to claim 1, wherein at least the first portion of the head of the brush and the perimeter frame are made of plastic material treated with antibacterial products.

7. The brush according to claim 1, wherein the first portion of the brush head has, on a first face external to the brush , a fin to which there is fixed an end part of the handle.

8. The brush according to claim 1, wherein said handle is made of embossed wood.
